(19) United States
(12) Patent Application Publication
(10) Pub. No.: US 2014/0049152 A1
(43) Pub. Date: Feb. 20, 2014

(54) VACUUM ELECTRON POWER TUBE

(71) Applicants: DAVID A. BALDWIN, Annandale, VA (US); Kevin L. Brown, Reston, VA (US)

(72) Inventors: DAVID A. BALDWIN, Annandale, VA (US); Kevin L. Brown, Reston, VA (US)

(21) Appl. No.: 13/966,608

(22) Filed: Aug. 14, 2013

Related U.S. Application Data
(60) Provisional application No. 61/682,977, filed on Aug. 14, 2012.

(51) Int. Cl. H01J 21/20; H01J 21/26

(52) U.S. Cl. CPC H01J 21/20; H01J 21/26
USPC 313/306

(57) ABSTRACT

A vacuum tube that may include but is not limited to a plurality of electrodes. A first electrode of the plurality of electrodes may be configured to operatively connect to an electrical source. A second electrode of the plurality of electrodes may be configured to operatively connect to a first load of a plurality of loads, wherein the first electrode may be configured to complete a first circuit through the second electrode and the first load. A third electrode of the plurality of electrodes may be configured to operatively connect to a second load of the plurality of loads that is independent from the first load, wherein the first electrode may be configured to complete a second circuit through the third electrode and the second load.

### RELATED CASES

This application claims the benefit of U.S. Provisional Application No. 61/682,977, filed on 14 Aug. 2012, by Baldwin et al., entitled Vacuum electron power tube with three output channels or three-phase output, the contents of which is all incorporated by reference.

### BACKGROUND

Vacuum electron tubes and various types of grid-controlled emitters of electrons may be known. Historically, such devices may have included, e.g., a single electron emitter and a single electron collector along with zero, one, two or more additional electrodes which may serve to turn on, turn off or variably influence or control the flow of electron current from the emitter to the collector. An “emitter” may also be called a cathode, an electron gun, a thermionic emitter, or a field emitter, among other names. A “collector” may also be called an anode, or a plate, among other names.

A single electrical power source may be used to supply multiple electrical devices or loads. When more than one load is to be powered or when more than one channel of electrical flow is to be regulated, two or more tubes may be used. This practice may be complicated and bulky. Additionally, waste heat from the several vacuum tubes may be distributed at disparate locations.

Example electrical energy storage and dispensing devices and systems may be becoming more feasible, and the number and kinds of high-power pulsed electrical devices may continue to increase, which devices may benefit from energy storage systems. In at least one form of electrical energy storage, e.g., electrostatic capacitors, high voltage storage may be preferred for high energy density. High-power pulsed devices may also benefit when supplied from a high-voltage electrical source. Vacuum tubes may have been adapted for control of high voltage flow of electricity.

### BRIEF SUMMARY OF DISCLOSURE

In one implementation, a vacuum tube may comprise a plurality of electrodes. A first electrode of the plurality of electrodes may be configured to operatively connect to an electrical source. A second electrode of the plurality of electrodes may be configured to operatively connect to a first load of a plurality of loads, wherein the first electrode may be configured to complete a first circuit through the second electrode and the first load. A third electrode of the plurality of electrodes may be configured to operatively connect to a second load of the plurality of loads that is independent from the first load, wherein the first electrode may be configured to complete a second circuit through the third electrode and the second load.

One or more of the following features may be included. The first electrode may include an anode, wherein the second electrode may include a first cathode, and wherein the third electrode may include a second cathode. The vacuum tube may further comprise at least one anode baffle, wherein the at least one anode baffle may be configured to restrict electron flow to near zero from the first cathode to the anode and from the second cathode to the anode, except as electron flow is permitted via at least one cathode interface structure. The vacuum tube may further comprise at least one cathode interface structure, wherein the at least one cathode interface structure may include electrically conductive material. The vacuum tube may further comprise at least one cathode interface structure, wherein the at least one cathode interface structure may include a non-perforated surface. The vacuum tube may further comprise at least one cathode interface structure, wherein the at least one cathode interface structure may be near anode electrical potential. The vacuum tube may further comprise at least one cathode interface structure, wherein the at least one cathode interface structure may include a hollow duct through which emitted electrons flow to the anode. The vacuum tube may further comprise at least one cathode interface structure, wherein the at least one cathode interface structure may include a hollow duct through which emitted electrons flow to the anode and wherein the hollow duct becomes larger in at least one of inside-diameter and inside-width with distance toward the anode. The vacuum tube may further comprise at least one cathode interface structure, wherein the at least one cathode interface structure may be configured to serve as an auxiliary anode surface, wherein an effective electron collection surface area of the anode may become larger as the anode-to-cathode potential difference decreases. The vacuum tube may further comprise at least one cathode interface structure, wherein the at least one cathode interface structure may be configured to create an accelerating electric field to draw electrons away from the cathode toward the anode. The vacuum tube may further comprise at least one cathode interface structure, wherein the at least one cathode interface structure may be configured to avoid concentration of high electric fields proximate to the cathode. The vacuum tube may further comprise at least one cathode interface structure, wherein the at least one cathode interface structure may be configured to prevent electrons originating at the first cathode from reaching the second cathode.

The first electrode may include a cathode, wherein the second electrode may include a first anode, and wherein the third electrode may include a second anode. At least a portion of the vacuum tube may be configured to at least one of focus a beam of electrons emitted from the cathode, and steer the beam of electrons emitted from the cathode. At least one of the first anode and the second anode may be configured to capture the beam of electrons which are at least one of focused and steered by at least the portion of the vacuum tube. The vacuum tube may further comprise at least one controller configured to synthesize a first sine-wave current waveform through the first load and synthesize a second sine-wave current waveform through the second load, wherein the first sine-wave current waveform may include a phase relationship with the second sine-wave current waveform.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a modified 2-dimensional projection and sectional view of a cylindrically symmetric electron tube that includes three cathode emitter sources and one common anode structure according to one or more implementations of the present disclosure;

FIG. 2 is an illustrative diagrammatic view of a electrical block diagram of a motor control system according to one or more implementations of the present disclosure;

FIG. 3 is an illustrative diagrammatic view of a modified 2-dimensional projection and sectional view of a cylindrically symmetric electron tube that includes three cathode emitter sources and one common anode structure, and an anode baffle that includes cathode interface structures according to one or more implementations of the present disclosure; and

FIG. 4 is an illustrative diagrammatic view of an electron tube that includes one common cathode emitter source and three anode plates according to one or more implementations of the present disclosure.

Like reference symbols in the various drawings indicate like elements.

### DETAILED DESCRIPTION

### System Overview:

Regulation of electrical energy from a single high-voltage source to multiple loads or channels may result in inferior implementations. For example, 3-phase inverters, which convert direct current (DC) to alternating current (AC), implemented with semiconductor switching elements, such as field-effect transistors (FETs), may not switch high voltages (such as more than 500 volts, for example) without the semiconductor devices themselves becoming problematic as regards low current-handling capability, cost, size, efficiency, cooling and other aspects.

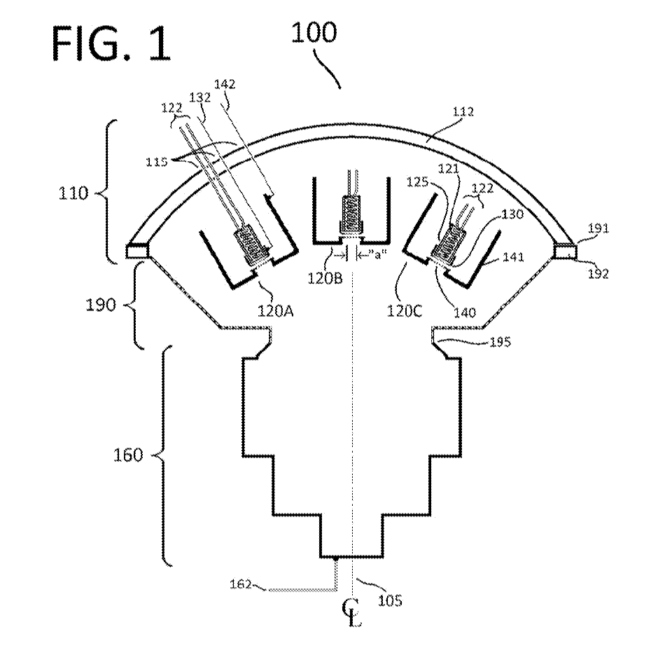

As will be discussed in greater detail, and referring also to FIGS. 1-4, a vacuum tube may comprise a plurality of electrodes. A first electrode of the plurality of electrodes may be configured to operatively connect to an electrical source. A second electrode of the plurality of electrodes may be configured to operatively connect to a first load of a plurality of loads, wherein the first electrode may be configured to complete a first circuit through the second electrode and the first load. A third electrode of the plurality of electrodes may be configured to operatively connect to a second load of the plurality of loads that is independent from the first load, wherein the first electrode may be configured to complete a second circuit through the third electrode and the second load.

The present disclosure may be used with many example applications without departing from the scope of the disclosure. For example, for vehicle propulsion applications and applications requiring similar levels of power, one or more 3-phase alternating current (AC) electric motor(s) with variable frequency may be useful by vehicle manufacturers for a variety of reasons. For example, using one vacuum electron tube to generate from a single electrical source all three phases needed for vehicle electric drive motors may help to reduce size, weight and complexity. In some implementations, a single vacuum tube may include but is not limited to three independent thermionic electron emitter sources, one for each motor phase, and a single common anode, all within the single vacuum tube. In some implementations, a single vacuum tube may include but is not limited to a single common thermionic electron emitter source, the electrons from which may be steered to three separate anodes, one for each motor phase, all within the single vacuum tube. In both of the example implementations, a vacuum tube may comprise a plurality of electrodes. A first electrode of the plurality of electrodes may be configured to operatively connect to an electrical source. A second electrode of the plurality of electrodes may be configured to operatively connect to a first load of a plurality of loads, wherein the first electrode may be configured to complete a first circuit through the second electrode and the first load. A third electrode of the plurality of electrodes may be configured to operatively connect to a second load of the plurality of loads that is independent from the first load, wherein the first electrode may be configured to complete a second circuit through the third electrode and the second load. A fourth electrode of the plurality of electrodes may be configured to operatively connect to a third load of the plurality of loads that is independent from the first load and the second load, wherein the first electrode may be configured to complete a third circuit through the fourth electrode and the third load, etc.

In some implementations, grid elements associated with each cathode/emitter may be used to control the amplitude and duration of the current emitted from each cathode, the current received at an anode(s) and therefore the power going to each of the three motor phases, independently. There may be many other ways to control an emission current and/or a current received at an anode besides the aforesaid grid elements, such as with a temperature of an emitter or a magnetic field, and any such methods may be referred to herein by terms such as “grid control”, “grid elements” and similar. Thus, according to one or more implementations of the present disclosure, one tube may control three (or two or more than three) power channels. Within either of the above approaches, or other approaches, electron current transfer functions of the tube may be determined or estimated for each of the three channels and stored in a grid-control drive circuit memory device or controller. These transfer functions may depend upon, among many factors, the level of cathode-to-plate (anode) current being conducted by the channel of interest, the level(s) of cathode-to-plate (anode) current(s) being conducted by the other two channels, the state of the electrical energy source feeding the tube, and the dynamic impedance presented to the tube by each phase of the motor (or other load), for example. Several sensors, rapid on-the-fly computations and dynamic adjustments to tube control signals may be desired to improve operation. In some implementations, one or more computing devices such as a microprocessor, a digital signal processor (DSP) or a field-programmable gate array (FPGA) may be employed to read sensors and perform the (optional) calculations to optimize efficiency, power throughput or other desired parameters. These and other functions described below may be included in the term “controller” used herein.

In some implementations, and referring at least to FIG. 1, an example of a cylindrically symmetric electron tube 100 comprising three cathode emitter sources and one common anode structure in a modified 2-dimensional projection and sectional view is shown. This is an example of the disclosed vacuum tube wherein a first electrode may include an anode, wherein a second electrode may include a first cathode, and wherein a third electrode may include a second cathode, and further wherein a fourth electrode may include a third cathode, etc. Center-line axis 105 of the tube is indicated in FIG. 1, though not all implementations of the disclosure need have such a centerline. The outer vacuum envelope of tube 100 comprises cathode housing 110, main high-voltage insulator 190 and anode structure 160. By way of example, cathode housing 110 may have a dome-shaped vacuum wall 112, which may reduce weight by enabling a thinner wall to stand off atmospheric pressure. By way of example, the anode structure depicted may be one type suited for liquid cooling of the anode from the outside of the anode vacuum wall, which wall may for example be constructed from highly conductive metal, such as copper, all of which may be better used for some high power applications.

In some implementations, and referring at least to FIG. 1, three cathode-emitter assemblies 120A, 120B and 120C are shown. The geometrical arrangement depicted for 120A-C may be somewhat arbitrary and dependent on certain design factors, examples of which may be given below. By virtue of projection onto a 2-dimensional page, some distortion may be included as drawn; for example, 120B may be behind or in front of the page, and the three cathode assemblies 120 may be arranged at equal 120° angular spacings around center-line axis 105 and equidistant from that axis. As drawn, cathode assemblies 120A-C may be “aimed” to project their respective electron fluxes into the lower, hollow regions of anode structure 160 where liquid cooling may be more easily provided. In the FIG. 1 example implementation and others, electron fluxes, floods, beams, distributions or plumes provided by cathodes 120A-C may be divergent, diffuse, broad, defocused, under-focused, over-focused or otherwise not precisely directed to a specific target. In some implementations, the areas of electron collection may be distributed as widely as possible over the interior surface of anode 160. Wide volumetric distribution of electron fluxes may reduce electron space charge density within the volume of anode 160. Wide areal distribution of electron collection reduces electron surface charge density over interior surfaces of anode 160. Wide areal distribution of electron collection may distribute heat produced by stopping and thermalization of high-velocity electrons, which may prevent hot spots on anode 160 and allow higher-power operation of tube 100 for a given size and mass of 100.

By way of example only and not to limit the scope of the disclosure, FIG. 1 depicts three tetrode type cathode assemblies 120. Each may comprise an indirectly-heated electron emitter 125 heated by a coiled filament 121, which may be galvanically connected (shown) or require a separate conductor (not shown) to close a circuit including emitter 125. Filament 121 may have two heater conductors 122 through which heating current may be passed; any electron emission current may be superimposed upon the heating current and be conducted through one or both wires 122. A first grid 130 may be located in conventionally close proximity to an electron emitting surface of emitter 125 and may serve as a primary control grid. A second grid 140 may be disposed down-stream (in the sense of prevailing electron flow) from first grid 130 and may serve as a further control grid, a screen grid, an accelerator grid, a suppressor grid or some combination of these functions. With anode 160 as a fourth (common) electrode, and its connecting conductor 162, each cathode/grid assembly 120 therefore may comprise a tetrode, at least in part. Tube 100 of FIG. 1 may be configured as a triode, a pentode, a hexode or other design without departing from the scope of the present disclosure. If configured as a pentode, for example, a next and outer grid 150 (not shown) may be present; the term “outer” may be illustratively described as farthest away from emitter 125. A diameter or width “a” denotes an effective size of the emissive area of cathode 120B, for reference. Conductors 132 and 142 permit application of control signals to grids 130 and 140, respectively. Outer shield 141 for each cathode assembly 120 is depicted as galvanically connected to grid 140, though this need not be the case and is so depicted only by way of example. Other configurations and modifications to the depicted structures to accommodate such other configurations may be implemented without departing from the scope of the disclosure. Likewise, components within each cathode assembly 120 may be supported and that each 120 may be supported within tube 100, as well as electrically isolated from each other and the walls of tube 100, and various ways of implementing these functions are omitted for clarity of the drawing. Further, conductors 122, 132 and 142 for each of cathode assemblies 120A, 120B and 120C may be implemented, and atmosphere-to-vacuum electrical feed-throughs may be provided, as indicated generically by feed-through set 115 for cathode assembly 120A in FIG. 1 (omitted for clarity for 120B and 120C). In many respects, as concerns any one cathode assembly 120 and grids 130, 140, etc., the present disclosure may be implemented using standard techniques known in the field of electron power vacuum tubes, as if there were only one such cathode assembly and one anode.

Since in some implementations, the disclosed vacuum tube may beneficially be used to control high voltage power, such as at 10,000 volts, for vehicular, industrial, military and heavy appliance/utility applications, FIG. 1 indicates some aspects of a heavy-duty, rugged, high-power tube, for example, though the disclosure is not limited to such. As mentioned before, anode structure 160 as drawn may be configured for immersion liquid cooling. Insulator structure 190 may stand off the preponderance of the high voltage, such as 10,000 volts, across the tube. For example, insulator 190 may be permanently joined to anode 160 at joint 195, which may be brazed or fused. This entire assembly 190-160 may be semi-permanently sealed in liquid-tight fashion to the aforementioned liquid cooling system for anode 160. Most waste heat dissipated in vacuum tubes may be concentrated in/at the anode; the disclosed multi-cathode/single-anode tube 100 thus concentrates heat at high temperature in anode 160. In some implementations, cathode/grid assemblies 120 may be replaced in case of wear and tear due to vibration, shock and/or age by opening tube 100 at joint 191. Flange or sealing surface 192 may be separable to access cathode/grid assemblies 120A, 120B, 120C, 120D or more while at atmospheric pressure. Assemblies 120 may be swapped out with new or rebuilt assemblies via withdrawal/insertion with plug-and-socket construction or other means. After servicing for extending lifetime of tube 100, tube 100 may be pumped back down to partial vacuum, such as 10⁻⁶ to 10⁻⁸ Torr and re-sealed, using ordinary light-industrial shop or depot tooling, then optionally brought to lower operation vacuum by evaporation of getter pumping material, or other established means.

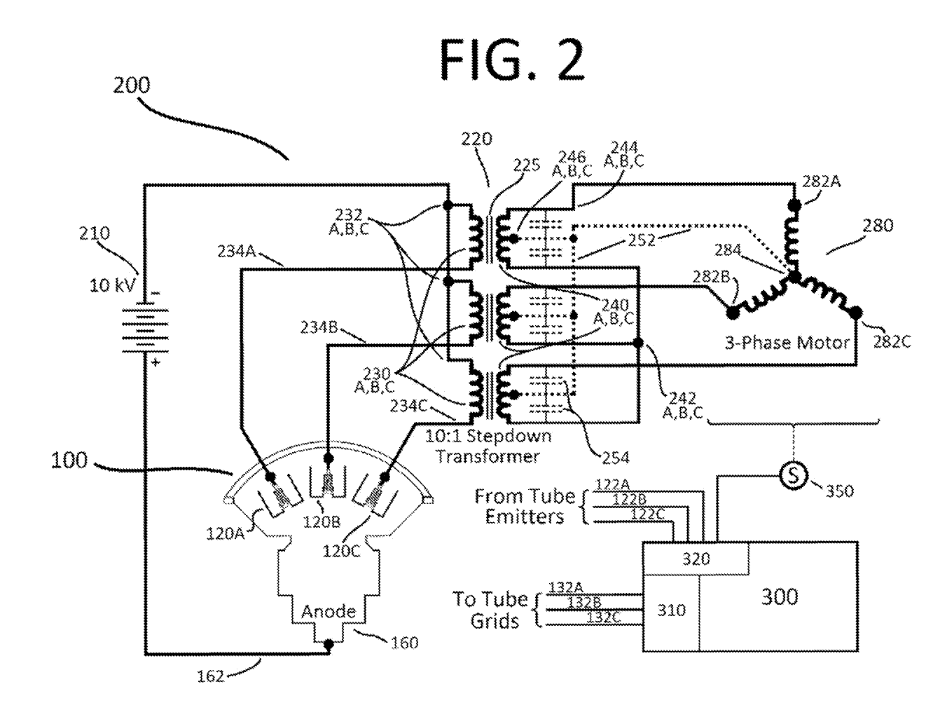

The disclosure may be better understood with reference to an example application circuit. FIG. 2 is an electrical block diagram of a motor control system 200 using the vacuum electron power tube example implementation 100 of FIG. 1, wherein a multi-channel regulated electrical load may be a variable-voltage, variable-frequency three-phase alternating current (AC) electric motor 280. For the sake of specificity in the example, without being thus limited, motor control system 200 may be powered by a single 10,000 volt direct current (DC) electrical power source 210, and the electric motor load 280 may be a 3-phase AC type operating near 1,000 volts across each motor winding. In one implementation of the disclosure, tube 100 may be controlled to produce three separate current-pulse trains of variable frequency, variable pulse-width and/or variable pulse amplitude that may, for this specific example, be stepped down in voltage with transformer 220 to synthesize 3-phase AC signals to actuate motor 280 precisely, with variable speed, variable torque and reversible rotation capabilities, among others.

In more detail, with reference to the example of FIG. 2, unipolar high voltage source 210, which is depicted with a symbol for an electrochemical battery but may equally be a bank of energy storage capacitors or other DC source, provides current at high electric potential, via its negative output, to a plurality of common primary winding taps 232A, 232B and 232C of step-down transformer 220. At the other ends of these primary windings 230, taps 234A, 234B and 234C are shown connected to the cathode emitters 120A, 120B and 120C of tube 100. As these cathodes are caused to emit, electron current flows to anode 160 of tube 100, then through conductor 162 back to the positive terminal of source 210, thus completing circuits through the primaries 230A, 230B and 230C of transformer 220. These are the principal circuits in the disclosure-relevant electrical topology, and they include elements such as a plurality of electrical loads (transformer primary windings 230) and electrical energy source 210 which reside, at least in part, external to vacuum tube 100. As described regarding FIG. 1, cathode emitters 120A, 120B and 120C of tube 100 may be controlled to emit electrons via some combination of grid control or electrode control, many methods for which may be well known in the art. For the sake of specificity in FIG. 2, these grid control elements are drawn as 130A, 130B and 130C (FIG. 1), which may be driven by signals imposed upon conductors 132A, 132B and 132C by controller 300 through output interface 310. Typically, control signals imposed on grid control elements 130A, 130B and 130C, as well as grids 140, 150, etc., if present, may be relatively low-voltage signals referenced to each cathode's emitter 125A, 125B and 125C, respectively. However, each cathode emitter may be at a high voltage, such as approximately negative 10,000 volts as shown in FIG. 2, with respect to the potential of other portions of the apparatus. These grid control signals may be generated by relatively low-power (compared to source 210) DC power supplies, amplifiers or potentiometers; ideally, the current drawn by these control elements is zero, but in practical apparatuses the current may be 0.01% up to a few percent of the emission current of each cathode. These control element circuits are not considered principal circuits in the disclosure-relevant electrical topology, and they typically do not include external (to the tube) electrical loads, though these circuits may extend external to the tube to include controller 300, for example, in FIG. 2.

As used herein, the term “load” or “electrical load” may mean, at least, any device which consumes electrical energy to produce work, heat, light, radiation, electromagnetic fields, chemical reactions, acoustic vibrations, signals, motion or any other energy-driven phenomenon. As such, a load may include other devices and systems which further process or otherwise use electrical energy for diverse purposes. In addition, the term “load” may include an energy storage element, a transmission line, an electrical generator/converter or any other non-end-use path or destination for electric charge, current and/or energy. A load may be located, at least in part, external to a vacuum tube of the disclosure. When referring to a plurality of loads, the disclosure may specify independent loads, which at least means that each load may have at least one electrical terminal or current input/output connection whereby a channel of a disclosed vacuum tube may inject or withdraw electric current from time to time, even though each load may also have another terminal in common (electrical conductive connection) with others of the plurality of loads, and even though each load may, in part, interact with or be influenced by others of the plurality of loads via electrical, mechanical or other coupling. The primary windings 230A, 230B and 230C of transformer 220 shown in FIG. 2 are an example of a plurality (3) of loads that include an electrical common connection and influence each other at least via magnetic coupling and mechanical inertia/momentum of the motor, yet these loads are considered independent for the purposes of this disclosure.

Thus, in some implementations, time-varying current signals may be driven by tube 100 through primary coils 230A, 230B and 230C of transformer 220, which may be a 3-phase transformer or three single-phase transformers, both of conventional type. On the secondary side of transformer 220, three secondary coils 240A, 240B and 240C are shown connected to the windings of 3-phase motor 280 according one of several configurations. In the example of FIG. 2, secondary taps 242A, 242B and 242C are shown tied together in common, and the other ends of the secondary coils, taps 244A, 244B and 244C, are shown connected to motor winding taps 282A, 282B and 282C. Optionally in some implementations, secondaries 240A, 240B and 240C may be provided with center taps 246A, 246B and 246C which may be tied together by common conductor 252 and, further optionally, the common conductor 252 may be connected to a common tie-point 284 of motor windings 282A, 282B and 282C. These last-mentioned optional connections are depicted with dotted lines in FIG. 2. Still further optionally, filter capacitors 254 may be added across secondaries 240A, 240B and 240C in various configurations, the capacitors 254 again depicted with dotted lines in FIG. 2. Optional center taps 246A, 246B and 246C and their common 252 may be desirable in apparatus 200 because mono-polar signals may be typically generated by the combination of electric source 210 and tube 100; the transformer secondary center taps may be a means of converting these mono-polar signals to bi-polar, AC signals. Optional filter capacitors 254 may be desirable, in some implementations, if time-varying current signals driven by tube 100 are chosen to be “square wave” current pulses but more nearly sinusoidal waveforms are desired to drive motor 280. Signal generation and control methods are discussed more thoroughly below. Optionally, transformer 220 is depicted in FIG. 2 with transformer core 225 using a symbol indicating a heavy ferromagnetic metal, which may be suitable for magnetically coupling long current pulses without magnetically saturating the core. Since tube 100 in combination with high-voltage source 210 may readily modulate current through primary windings 230A, 230B and 230C at frequencies of 10 kHz, 100 kHz, 1 MHz and higher, transformer core 225 may optionally be a ferrite material core or even an air core, since current flow durations may be shorter and not likely to saturate the core. Such a core may be at least lighter in weight and may also be smaller in volume, thus beneficially reducing the cost, weight and size of system 200. Considering the foregoing, and attributes of the example implementations given below, multi-cathode tube 100 of the disclosure may provide significant advantages over existing DC-to-AC converters, such as semiconductor-based full-bridge or H-bridge inverters. The high voltage capability and electrical fault-tolerance of vacuum tubes over power semiconductors may be established. The concentration of high-temperature waste heat by the disclosed vacuum tubes, where it may be managed simply, for example by existing automotive vehicle radiators, and/or from which usable energy may be extracted, as in co-pending U.S. patent application Ser. No. 13/544,302 filed 9 Jul. 2012, may not be readily achieved by semiconductor arrays, which may produce distributed heat at temperatures under 200, 250 to 300° C. The control and signal generation options of tube 100 given below may be beneficially and desirably numerous and broad; these are thought to exceed the practical flexibility of semiconductor-based converters. In some implementations, a multi-channel power control system of the disclosure may be lighter, smaller and cheaper than an equivalent system implemented using semiconductors, especially in many applications wherein the magnitude of power may be 10 kW, 100 kW, 1 MW and higher.

### Example Implementation

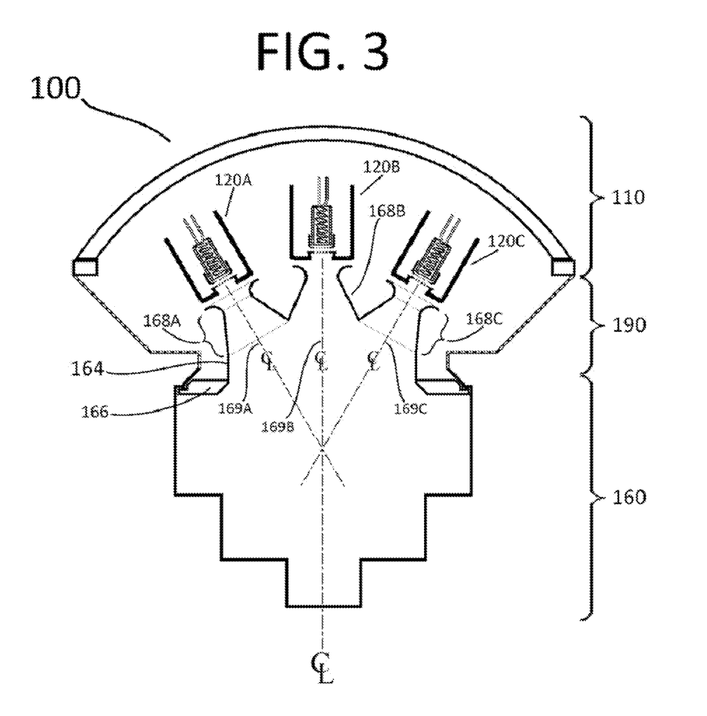

FIG. 3 depicts an example implementation of vacuum power electron tube 100 which may enable improved operation of apparatus 100, particularly in a system such as 200 in FIG. 2, which may be used to illustrate some aspects of the example implementation. Tube 100 of FIG. 3 is shown in a modified 2-dimensional projection and sectional view similar to the view of FIG. 1, and tube 100 of FIG. 3 may be approximately the same as tube 100 in FIG. 1 in all respects described relative to FIG. 1. In FIG. 3, tube 100 additionally comprises an anode baffle 164. Anode baffle 164 may be fabricated of electrically conductive material, preferably continuous (non-perforated) material, and may be fixed to anode 160 by any of several convenient mechanical mounting means, such as mount 166 depicted in FIG. 3, whereby anode baffle 164 may be preferably at anode electrical potential. In some implementations, anode baffle 164 may be fabricated of insulating material or may be electrically isolated (floating) but still desirably may restrict electron flow to near zero from any cathode-emitter assembly 120 to the anode, except as electron flow is permitted via at least one cathode interface structure. Anode baffle 164 supports three cathode interface structures or cathode “horns” or tapered ducts 168A, 168B and 168C, which may be conductive, non-perforated and connected to anode potential. The cathode interface structures may be fashioned as hollow ducts through which emitted electrons from each cathode-grid assembly 120A, 120B and 120C may pass to reach the main anode structure 160, which may be shared in common by all the cathode assemblies according to a multi-cathode implementation of the disclosure. The cathode interface structures bring anode potential close to each cathode-emitter assembly so that a strong accelerating electric field is created to draw electrons away from the cathode toward the anode, but the cathode interface structures may be intended to, for the most part, not intercept emitted electrons or electron current but rather to pass the electrons and electron current through for actual collection by the anode in the lower regions (as drawn) of anode 160. However, at times under special conditions described below, cathode interface structures 168 may receive electron current and act as an auxiliary anode. Since the electrons may be primarily intended to pass through the cathode interface structures, center-line 169A of hollow cathode interface structure 168A may approximately coincide with a principal center-line of cathode-emitter 120A in the direction of electron emission. A similar geometric relationship pertains relative to 169B, 168B and 120B; 169C, 168C and 120C; and any fourth, fifth and so forth cathode-emitters. In the implementation of FIG. 3, both the emitters 120 and cathode interface structures 168 may be generally cylindrically-symmetric, but it may be appreciated that linear, slit-like emitters could be used in cathodes 120 which may then be matched with generally rectangular cross-section cathode interface structure ducts 168. Thus it is a principle of the disclosure that cathode interface structures 168 may be electron-optically matched with the form and geometry of the electron-emissive plane of whatever cathode-emitters 120 may be chosen, though this matching may be a design choice and not limiting of the scope of the disclosure. In some implementations, the hollow interior of the electron duct of each cathode interface structure 168 is depicted to and may generally widen, become larger in inside-diameter, become larger in inside-width and/or become larger in cross-sectional area as a function of distance toward the anode, i.e., along the direction of electron flight. In some implementations, the cathode end of one or more cathode interface structures 168 may be smoothly curved as drawn, by way of example and not limitation, to avoid concentration of high electric fields proximate to the cathode at sharp points or edges, and this smooth shape is believed to allow operation of the tube at high voltage differences, such as 10,000 volts or higher, as in example system 200 of FIG. 2. To clarify, a high electric field may be intended to exist between a cathode interface structure and its respective cathode, but the configuration to avoid concentration of high electric fields proximate to the cathode may prevent irregularities in the electric field resulting in even higher-than-intended localized electric fields. In summary, an example design for a cathode interface structure 168 of the disclosure may be quantified in multiples of length “a”, which may be an effective emissive diameter of a cathode 120 (shown for 120B in FIG. 1). The spacing of the near-cathode end of the cathode interface structure may be ˜1a from the outer grid, the total length of the cathode interface structure along axis 169 may be ˜5a, the length along axis of the smoothly curved near-cathode end of the cathode interface structure may be ˜1a, the length along the axis of the expanding portion of the cathode interface structure may be ˜4a, the minimum inside-diameter of the cathode interface structure may be ˜2.6a and the maximum inside-diameter of the cathode interface structure where it meets anode baffle 164 may be ˜6.1a. The half-angle of expansion of the cathode interface structure may be ˜25°. These example proportions may be varied individually or in combination while still maintaining a similar electron-optical or plasma-optical function and thereby remain within the scope of the disclosure. Also, as may be evident from the definition of the length “a” above, a cathode interface structure may be scaled up or down in overall size without departing from the scope of the disclosure.

Cathode interface structures 168A, 168B and 168C serve several electron optics functions which may be closely related to electrical performance of tube 100 within a system such as 200. Each cathode interface structure brings anode potential quite close, a distance that may be approximately 2a or less, to the outer grid of its respective emitter 120. This may beneficially provide high electric field extraction and acceleration of emitted electrons. The electric field in the cathode-to-cathode interface structure region may be approximately E_{accel}=ΔV_{anode-cathode}/2a. (The electric field may be reduced from the higher, geometrically-implied value of E_{accel}=ΔV_{anode-cathode}/a because of the open aperture of the near-cathode end of the cathode interface structure and the bending of equipotential contours in that open-space region.) Beneficially, this extraction field may be approximately independent of any condition of the other two cathodes, as may be shown later herein. The example implementation may be arranged such that a) each cathode 120 has its matching cathode interface structure 168, b) the cathode interface structures may be tightly joined to anode baffle 164 at their distal ends from their respective cathodes 120 and c) anode baffle 164, together with the cathode interface structures, may desirably mechanically isolate an upper (as drawn) cathode region of tube 100 from a lower (as drawn) interior cavity of anode 160. Such mechanical isolation may restrict electron flow to near zero from any cathode-emitter assembly 120 to the anode, except via the aforementioned cathode interface structures. Together with the aforementioned E_{accel} between each cathode interface structure and its corresponding cathode, this mechanical isolation may normally prevent electrons originating at any given cathode from reaching any of the other cathodes, from any direction. Sometimes electrons from one cathode may be electrically attracted to another cathode, as may be shown later herein, if the aforesaid fields and mechanical isolation were not provided. At certain other times and under specific conditions, electrons from one cathode may travel to and be collected at another cathode, in spite of the aforesaid fields and mechanical “isolation”. Such charge sharing or current leakage between cathode channels may be detrimental in several possible ways but also may be acceptable or beneficial if managed according to principles of the disclosure, as may be shown later herein. Cathode interface structures 168 may provide alternative surfaces upon which electrons may be collected to the anode electrode, since the cathode interface structures may be preferably conductive, galvanically connected to the main anode 160 and may be near anode 160 potential. A problem with high power, high current electron tubes which are relatively compact in volume may be the phenomenon of “space charge”. Space charge Qᵥₒₗ(x,y,z) [C/m³] may be the volume number density of electrons nₑ(x,y,z) [electrons/m³] times the charge of an electron “e” [C/electron] within the interior of tube 100 at the point having location coordinates x, y and z. When an electron beam carrying a current I [C/s] at velocity v [m/s] and having diameter d [m] passes through, near or around a point,

Qᵥₒₗ=e·nₑ=4·I/(π·v·d²) Eqn. 1

in the vicinity of that point. Electron fluxes may be not always at one velocity in a defined beam diameter, but Qᵥₒₗ may, if non-zero, change the electric potential in the space through which electrons travel, thus change electric fields, electron velocities and other parameters. As may be shown later herein, these changes may often result in poorer performance of tube 100. Generally, the higher Qᵥₒₗ, the less desirable the performance. The disclosed design of cathode interface structures 168 may reduce a magnitude of Qᵥₒₗ by mechanical exclusion of electrons, by collection of electrons on cathode interface structure surfaces and by providing electric fields which may repel some electrons. These and other electron-optical functional aspects of cathode interface structures 168 may improve an electrical performance of tube 100 and may be better understood by reading the following explanation. Cathode interface structures 168 may increase dIₑₘᵢₛₛ(t)/dt, an initial rate of rise of emission current, produced by cathodes 120A, 120B and 120C for short times near t=0, where t=0 may be the time at which grid 130 changes electric potential to gate electron emission from emitter 125 from off to on. Cathode interface structures 168 may increase Iₑₘᵢₛₛ(t_{steady}), an emission current value that may be a maximum, peak or steady-state value occurring at a later time t_{steady}, sometime after t=0. These and other increases or improvements may be relative to a version of tube 100 without anode baffle 164 and without cathode interface structures 168, such as depicted in FIG. 1. These and other increases or improvements in electrical performance may be beneficial for high-power, short-pulse applications of tube 100 of FIG. 3.

A vacuum electron tube of similar design to tube 100 of FIGS. 1 and 3 in series with a load having non-zero load resistance or load impedance may usually undergo a phenomenon herein referred to as “ΔV_{anode-cathode} collapse” to some degree when going from an “off” state to a conducting state. ΔV_{anode-cathode} may be defined as the potential difference between the anode and the cathode of any single conductive channel of tube 100. Note that as used herein applied to voltages and potentials, Greek “Δ” (delta) refers to a difference between two physical locations or components, not a difference over a period of time. Referring to FIG. 2, it may be seen that when any one cathode 120 channel is conducting current (emitting electrons), current may flow through the corresponding series load channel, which may be one of transformer 220 primary coils 230A, 230B or 230C in the example system 200 of FIG. 2. A voltage drop may occur across this load channel. In a desired operating mode of the system, most of the voltage of source 210 may appear across this channel's load, so that most of the channel power (P=ΔV·k_{chan}, where V is voltage [v] and I_{chan} is a current [A] drawn by this channel) may be transferred to the load in that channel, and little electrical power from this channel may be dissipated in tube 100. Therefore, strong ΔV_{anode-cathode} collapse may be highly desired in any strongly-conducting channel for efficient operation of tube 100.

Strong ΔV_{anode-cathode} collapse in a channel may cause an active (conducting) cathode 120 to shift its electrical potential V_{cathode} to a value much nearer to the potential V_{anode} of anode 160. In more detail, as grids 130, 140, 150, etc. change electric potentials to increase or decrease emission from emitter 125 (see FIG. 1), the potential difference ΔV_{anode-cathode} between emitter 125 and anode 160 may decrease or increase, respectively, because of impedance R_{load} of load 230. This inverse relationship between cathode potential and emission current may be understood as a manifestation of Ohm's Law in the load, expressed as

ΔV_{anode-cathode}=ΔV_{source}−ΔV_{load}=ΔV_{source}−(Iₑₘᵢₛₛ·R_{load}), Eqn. 2

for any one cathode 120A-C, its load current Iₑₘᵢₛₛ and its load impedance R_{load}. For this formula, a relatively constant voltage ΔV_{source} applied across the series-connected load and tube channel may be assumed, as configured in FIG. 2, wherein ΔV_{source}=10,000 volts, by way of example and not limitation. Also, it is assumed that Iₑₘᵢₛₛ=I_{load}, which may mean that there is little charge leakage or “cross-talk” between channels. Eqn. 2 says that ΔV_{anode-cathode} in a channel may be strongly dependent upon the voltage dropped across the load in that channel, which may be dependent upon the load impedance and the emission current cathode 120 of that channel is able to emit or is controlled to emit by grids 130, 140, 150, etc. However, Eqn. 2 also says that as ΔV_{anode-cathode} approaches zero, Iₑₘᵢₛₛ may reach a maximum value, in spite of the fact that cathode 120 may be able to provide larger emission current values and regardless of any higher emission current values “requested” by grids 130, 140, 150, etc. It may be the case that the voltage ΔV_{source} and the load resistance R_{load} simply will not allow higher current to flow. Historically, some practitioners may have referred to this condition in single-channel vacuum tubes as “saturation”. A similar condition may exist in any channel(s) of the disclosed multi-channel vacuum tube. While saturation of a channel may be an acceptable mode and may cause near minimum power to be dissipated in tube 100 by that channel, saturation is an incidental phenomenon, is a design choice and is not essential to or limiting of the practice of the present disclosure.

In the example implementation, V_{cathode}≈V_{formation}≈V_{emitter,125} may be dynamically rising and falling in response to changes of the channel's the load impedance and the emission current parameters while both ΔV_{source} and V_{anode} may be approximately constant. Therefore, in a multi-cathode tube, if a first cathode is emitting current intensely while a second cathode is emitting current only weakly, the potential of the first cathode assembly may have experienced a large ΔV_{anode-cathode} collapse while the potential of the second cathode assembly may have experienced only a small ΔV_{anode-cathode} collapse. This means that V_{cathode,first} may be nearly equal to V_{anode} while V_{cathode,second} may be nearly equal to V_{source,negative}, the potential of the negative terminal of DC power source 210. In that case, electrons emitted from the second cathode may be attracted to the first cathode assembly similarly as they are attracted to anode 160. If not prevented, this may constitute undesirable charge leakage or “cross-talk” between channels. As disclosed and described earlier herein, anode baffle 164, cathode interface structures 168 and the electric fields E_{accel} existing between cathode interface structures 168 and cathode assemblies 120 may prevent such movement of electrons emitted from any cathode to any part of any other cathode(s), among other design purposes.

The above-mentioned ΔV_{anode-cathode} collapse and its corresponding reduction in the magnitude of V_{cathode} (that is, bringing it closer to V_{anode}), causes the kinetic energy of electrons passing through tube 100 to be reduced, and the slower speed of electrons may reduce a maximum Iₑₘᵢₛₛ=I_{load} current a channel of the tube can conduct and/or reduce a speed of responsiveness dI_{load}/dt the tube can exert when I_{load} is already large for that channel. The kinetic energy E_{K} to which an electron may be accelerated may be related to the electric potentials via

E_{K}(z)=e·V(z)−e·V_{formation}=e·V(z)−e·V(z=0), Eqn. 3

where “e” is the charge of an electron [C/electron], V(z) is the potential [J/C] at some distance z along cathode interface structure center-line 169 or tube center-line 105, and V_{formation}=V(z=0) is the potential at z=0 where the electron had approximately zero (or thermal) kinetic energy, which for a thermionic emitter may be taken to be the potential of the emitter from which the electron initially “boils” to become free in the vacuum; thus V_{formation} approximately equals V_{emitter,125}≈V_{cathode}. E_{K}(z) becomes negative, it means that the electron may not go to that z-region and may have been reflected or deflected before reaching there. The speed of the electrons may be related to their kinetic energy by E_{K}=0.5·mₑ·vₑ², where mₑ is the mass of the electron and vₑ is its speed. Once an electron has traveled a distance of one or a few diameters of cathode interface structure 168 into cathode interface structure 168, the electron may be considered to be in a field free drift region at anode potential, if there is zero space charge Qᵥₒₗ inside the anode. The electron may reach its terminal velocity in the hollow, equipotential interior of anode 160, if 160 is formed as shown in FIGS. 1 and 3. The electron may travel at constant speed in a straight line until it strikes an interior wall of 160 where it may be collected. In that region, the electron has a kinetic energy E_{K}(z_{anode})≈e·ΔV_{anode-cathode}, where ΔV_{anode-cathode} is given by Eqn. 2. Thus parameters of system 200 such as source 210 voltage, load 230 impedance and load current directly determine the final kinetic energy and terminal velocity of an electron. Generally, the higher Iₑₘᵢₛₛ, the slower the electron travel speed vₑ through cathode interface structure 168 and through the open volume of anode 160. As may be well known in the field of electron optics, the speed or speed change of electrons passing through a lens array or sequence of grids may be a primary parameter affecting the focusing of electrons or bending of electron trajectories. The value of ΔV_{anode-cathode} and any time-variation of ΔV_{anode-cathode} within the electron-optical regions of tube 100 has profound impacts upon electron extraction, acceleration and beam forming at/from an active cathode. Generally, at smaller ΔV_{anode-cathode} (lower vₑ), the maximum possible electron beam (or flood) current and current density (see Eqn. 4) may tend to decrease, the beam diameter may increase and/or a beam divergence angle may increase. In an extreme case, I_{anode} may be less than the Iₑₘᵢₛₛ that cathode 120 may be attempting to emit or readily emits when ΔV_{anode-cathode} is larger. Taking account of this beam expansion at low electron energy, the disclosed cathode interface structures a) optionally become larger in diameter with distance toward the anode 160 and b) may serve as auxiliary surfaces whereby an effective electron collection surface area of anode 160 may become larger as ΔV_{anode-cathode} decreases. These features may improve electrical performance of tube 100 at least because a possible electron-optics-limited current throughput of the tube, I_{anode,max}=Iₑₘᵢₛₛ (t_{steady}), where t_{steady} denotes a time after cathode switch-on that may be long compared to the rise-time of emission current, may be increased.

The cathode interface structures 168A, 168B and 168C serve functions to mitigate the effects of space charge, particularly effects arising from the disclosed multi-channel, multi-cathode nature of tube 100. In a multi-cathode tube, the flood of low energy electrons in the anode region from one active (conducting) cathode may create negative space charge (see Eqn. 1) which may affect (reduce) the extraction and acceleration electric fields of the other two (or more) cathodes, if this space charge were allowed to come near the other cathodes. This last mentioned electron density in the open volume regions of anode structure 160 may “screen” anode potential from the cathodes 120. In some cases, the turn-on time or time-ramp-up of current from an off state to a conducting state may take longer; this is sometimes undesirable. The disclosed element of cathode interface structures 168A, 168B and 168C shown in FIG. 3 overcomes this problem by bringing anode potential very near each cathode 120 via a conductive structure 168. Lower energy electrons produced by other conducting emitters 120 may not be able to reach the cathode-end of cathode interface structures 168, because they may be repelled by the strong electric fields in the gap between the cathode end of 168 and the cathode assembly 120. This may be true of lower energy electrons regardless of their origin. It may be well known that high energy electrons striking the interior of anode 160 walls, so as to be collected, may instead scatter back into the volume of 160 but at a lower kinetic energy. Also, high energy electrons striking the interior of anode 160 walls may liberate secondary electrons into the volume of 160 at a wide range of (lower) kinetic energies. There may be other mechanisms of producing lower energy electrons, as well. The disclosed anode baffle structure 164 comprising cathode interface ducts 168 for each cathode-emitter 120 in a multi-cathode electron tube provides approximately the full voltage of source 210 (see FIG. 2) to be applied across the gap between the cathode end of 168 and cathode assembly 120 of a non-conducting cathode 120, even if other cathodes 120 are conducting and have lowered their voltage close to anode 160 potential. Therefore the turn-on or current-rise time performance of each cathode 120 of the disclosure is approximately the same as in a single-cathode tube, even though cathode 120 is actually in a multi-cathode tube, and the other cathodes may be conducting or not. This aspect of the disclosure comprising plural cathode interface structures or cathode interface structures 168 provides fast rise time of Iₑₘᵢₛₛ of tube 100 and does so whereby this rapid rise time performance may be approximately independent for each cathode 120 relative to the other cathodes 120.

After an initial Iₑₘᵢₛₛ turn-on time period within any one channel of tube 100, disclosed controls may adjust Iₑₘᵢₛₛ to provide a highly efficient current-pulsed multi-channel high power tube. Within any one current pulse, or before a pulse starts, a desired final value of Iₑₘᵢₛₛ may be estimated then targeted by controls. Best efficiency may be achieved when ΔV_{anode-cathode}, which starts at ΔV_{source} when Iₑₘᵢₛₛ=0 (see Eqn. 2), collapses to as low a value as possible without damage or loss of intended function. When ΔV_{anode-cathode} is low, much power may be delivered to a load and little power may be dissipated (wasted as heat) in tube 100. Therefore, according to Eqn. 2, it may be desired to drive Iₑₘᵢₛₛ as high as possible without damage or loss of intended function, even into the regime of emission saturation, as defined above. The disclosure provides means to estimate and set a desired high, efficient value of Iₑₘᵢₛₛ for each channel of tube 100, those channels being cathode 120A to anode 160, cathode 120B to anode 160 and any other channels. Estimating a desired high value for Iₑₘᵢₛₛ for one channel may involve taking into account some parameters, states or conditions of the other channels of tube 100. Child's Law, the values of ΔV_{anode-cathode} for each channel, the values of Iₑₘᵢₛₛ for each channel and estimates of space charge Qᵥₒₗ at certain locations in tube 100 may be involved in making those estimates of desired Iₑₘᵢₛₛ values. These may be explained with reference to TABLE 1, which also clarifies how Iₑₘᵢₛₛ may be targeted or set by controls of the disclosure.

TABLE 1
Effects or Conditions which Determine Iₑₘᵢₛₛ from any Cathode 120 having
area ~a²

| | |
|---|---|
| 1 | Temperature or other intrinsic property or state of emitter 125 |
| 2 | Electric field applied to surface(s) or region of emitter 125 by control |
| | grid 130 |
| 3 | Space charge and electric potentials within/between grids 130, 140, |
| | 150 and so forth |
| 4 | Space charge and electric potential between outer grid (140, 150 or |
| | other) and cathode interface structure 168 |
| 5 | Load impedance, i.e., external limit on electron current from cathode |
| | to anode |

The Table 1-1 value of temperature may be set at a convenient emissive value and left there, or it may be varied to increase or decrease a certain intrinsic limit to current density emitted from 125, though temperature changes may to be too slow for most control means provided below herein. If the Table 1-1 parameter can be changed at ˜MHz speeds, then it may be used in conjunction with the Table 1-2 parameter. The Table 1-2 value of extraction field or applied potential between emitter 125 and control grid 130 may function by a field-augmented emission process at 125 and also may be affected by Child's Law limits. The Table 1-2 parameter may be the primary control of Iₑₘᵢₛₛ giving fast response (0.1 to 100 MHz or higher) when Iₑₘᵢₛₛ is not limited by other conditions. In most configurations of emitter 125 and control grid 130, Iₑₘᵢₛₛ extracted from 125 may be smoothly and continuously varied via adjustment of a potential on grid 130. The Table 1-3 and Table 1-4 parameters may be strongly affected by Child's Law limits. Child's Law estimates a maximum electron current density Jₘₐₓ [A/m²] that can flow or be accelerated between two planes and may be given in one-dimensional form as:

Jₘₐₓ=(4·ε₀/9)·(2·e/mₑ)^{1/2}·V(z)^{3/2}/z² Eqn. 4

where ε₀ is the permittivity of vacuum, “e” is the charge of an electron, mₑ is the mass of an electron and V(z) is the potential difference between a plane at distance z and a plane at z=0 where the electrons originated at thermal velocities. When this Jₘₐₓ limit is reached, the space charge of the flowing electrons may have canceled or reduced to zero the electric field at the plane of origin, meaning, in theory, that no more electrons will be accelerated in the z-direction. Lateral spreading of the electron flux also typically occurs. The average kinetic energy of the electrons in the stopped flood tends toward zero (thermal), which may decrease the Debye length of the electron cloud, considered as a plasma. When the Debye length becomes smaller than the openings in grids 130, 140, etc., a screening sheath develops around each grid strut and some electrons flow through the grid holes as if the grid did not exist, which typically ruins the electron optical design of cathode 120, often causing short-circuits, electrical arc damage and/or other counter-functional results. With respect to the Table 1-4 parameter, ΔV_{anode-cathode} may be dominant, and as it becomes smaller, V(z) of Eqn. 4 becomes smaller, reducing Jₘₐₓ. Smaller ΔV_{anode-cathode} may also affect the Table 1-3 parameters by suggesting a control-driven reduction in one or more potential differences between grids 130, 140, 150, etc., lest the outer grid become more positive than V_{anode}. Reduction of potential differences between grids likely reduces V(z) in Eqn. 4, which reduces Jₘₐₓ·a², which reduces Iₑₘᵢₛₛ; “a” is defined above as an effective emissive width of a cathode. As may be known in electron optics, Child's Law (Eqn. 4) may be applied repeatedly in a series chain of electron-optical elements, and the minimum Jₘₐₓ of any element in the chain sets the Jₘₐₓ limit for the whole chain.

The disclosure provides management of ΔV_{anode-cathode} collapse and its effect of possibly leading to cross-talk or charge leakage between channels of a multi-cathode tube. One example of how this may happen was given in the last paragraph. Strong reduction in ΔV_{anode-cathode} may lead to the outer grid or electrode of cathode 120 assuming an electric potential which is more positive than V_{anode}. When this happens, the outer grid may collect electrons from any space charge existing in its nearby cathode-to-cathode-interface-structure gap. Since the grids 130, 140, 150, etc. may be typically biased with reference to emitter 125 and galvanically connected to 125 through the bias voltage supply or source, a collecting of electrons on any grid (or shield 141) represents a reduction in Iₑₘᵢₛₛ for the affected channel. This collecting of outside electrons at any portion of a cathode assembly 120 may be called “back-streaming”, to distinguish from the usual collecting of “local” electron current which may occur upon any grid that is more positive in potential than V_{cathode}≈V_{emitter,125}. If the collected electrons originated from a different channel in a multi-cathode tube, this collection of space charge electrons from the cathode-to-cathode-interface-structure gap may represent “cross-talk” or charge leakage between channels. Within the disclosure, it may be certainly permissible for some grid potentials to become more positive than V_{anode}, but preferably this may be managed, for example by designing interior of anode 160 volume to collect or trap most electrons so that few actually reach any of the several cathode-cathode interface structure gaps, even though they may not be electrostatically prevented from doing so. Alternatively, some leakage current may be permitted by controller 300, if judged not to significantly interfere with function of system 200 at a point in time so judged. For example, one criterion upon which to judge permissibility of cross-channel charge exchange at an outer grid or outer shell 141 of cathode assembly 120 relies upon the fact that, the most likely way for this to happen may be when two or more channels are conducting large Iₑₘᵢₛₛ, which may mean that both channels, if reasonably matched in construction/geometry, will be suffering strong ΔV_{anode-cathode} collapse and therefore have small ΔV_{anode-cathode} values. If the ΔV_{anode-cathode} values of conducting channels are similarly low in magnitude, then all conducting cathodes 120 may be attracting space charge electrons from the general tube-wide population of those electrons, each doing so probably at its cathode-to-cathode-interface-structure gap. The result may be that each I_{emiss,ChanA}, I_{emiss,ChanB} and so forth will be reduced by some predictable amount relative to what its Iₑₘᵢₛₛ might be if no other channel were conducting. As explained above, any non-conducting channels or weakly conducting channels may have large ΔV_{anode-cathode} values and therefore may not receive any leakage electron current. This state of affairs may be entirely acceptable. There may be numerous other scenarios made possible within the disclosure, whereby, for another example, controller 300 may arrange for the ΔV_{anode-cathode} value of one channel to be always high enough that it can donate electrons to the general population of space charge electrons but never receive electrons from that population. Other examples could be propounded. Finally, it may be noted that channel cross-talk or charge leakage may occur even when no grid potentials are more positive than V_{anode}. If one or more channels is moderately conducting and therefore has moderately high ΔV_{anode-cathode}, the kinetic energy of electrons injected into anode 160 by such channels may be moderately large, and back-scattered electrons off anode 160 walls from these electrons may have smaller but still moderately large E_{K}, which may overcome the electric field barrier E_{accel} at some other cathode-to-cathode-interface-structure gaps and thereby be collected on other cathode 120 outer grids, outer shields 141 and so forth. Such phenomena may not be very detrimental. Such phenomena may be a minority process in a well-designed tube 100, may be very predictable, may be avoided by control choices, and may not be particularly destructive in most cases. Usually the effect may be a perturbation of Iₑₘᵢₛₛ from an expected value for one or more channels.

A common problem with high-power, rapidly-switched electrical systems may be generation of electromagnetic interference (EMI), either conducted, radiated or, in some cases, mechanically materials-coupled (for example, microphone or piezoelectric effects). Within a system, such as 200 of FIG. 2, EMI may cause noise or inaccuracy of several measurements and/or control signals, particularly when these are in high-impedance electrical paths. Outside of such a system, for example in the vehicle being powered, EMI may affect radio signals (entertainment/news broadcasts, critical organization communications bands, cellular phones, GPS, local links such as blue tooth, and others), computing devices, data storage devices, pace makers/medical devices and many other electronic devices. One prime source of EMI may be rapid change of current, dI/dt, which induces a traveling magnetic field wave in the volume around any conductor through which current is changing. Generally, the magnetic flux density may be proportional to I, while EMI may be proportional to both I and dI/dt. A FET inverter, to which the present disclosure has been compared above, may exhibit sudden switching, and transients therefrom, with many high-frequency Fourier components having large dI/dt, and this may be difficult to moderate without addition of extra electrical devices (e.g., snubbers), which may need to be sized commensurate with the full load power of the inverter, or without permanent, constructive changes to the transistor's drain-channel-source and gate make-up. By contrast, tubes like 100 may be relatively easy to control on-the-fly to create soft-start or soft-finish changes in current, with even more rapid slewing in between end states than FETs because electrons may move faster in a vacuum than in a semiconductor material. Upon initial turn-on from the non-conducting state of a cathode 120 of the disclosure, Iₑₘᵢₛₛ may be small and dIₑₘᵢₛₛ/dt may be kept small by, for example, limiting a slew rate of a control voltage on control grid 130, which may be done with devices and controls sized for 1%, 0.1% or smaller of the load power. The value of dIₑₘᵢₛₛ(t_{mid})/dt, where t_{mid} is a time value between t₀ and t_{steady}, may be selected in tube 100 by several means and, equally importantly, may be relatively constant during the rise of Iₑₘᵢₛₛ and the corresponding build-up of magnetic field energy around conductors, thereby having only a narrow equivalent frequency band and very small high-order Fourier components. The behavior of dIₑₘᵢₛₛ(t→t_{steady})/dt, when Iₑₘᵢₛₛ approaches a maximum, peak or steady-state value, may be a region in which tube 100 excels in controlling EMI. This may be the most important region, since when Iₑₘᵢₛₛ is already high, the magnetic field around conductors may be already extensive and has large stored energy, so dIₑₘᵢₛₛ/dt induces a traveling magnetic field wave carrying high energy. dIₑₘᵢₛₛ(t→t_{steady})/dt may be relatively “soft” (low), and its behavior may be strongly influenced by the aforementioned ΔV_{anode-cathode} collapse phenomenon. A desired final (t→t_{steady}) value of Iₑₘᵢₛₛ may be estimated then targeted by controls, as discussed above. The targeted final value of Iₑₘᵢₛₛ may be selected to moderate dIₑₘᵢₛₛ(t→t_{steady})/dt and reduce EMI. In particular, if the targeted final value of Iₑₘᵢₛₛ is high enough that it cannot be reached before onset of electron back-streaming, electron beam expansion and other electron-optical phenomena discussed herein, the choices for controlling dIₑₘᵢₛₛ(t→t_{steady})/dt by selecting targeted final values of Iₑₘᵢₛₛ may be very numerous. As disclosed herein, within the context a multi-cathode tube, at least space charge and cross-channel charge sharing may be used to further control dIₑₘᵢₛₛ(t→t_{steady})/dt in any channel in coordination with controlling Iₑₘᵢₛₛ and ΔV_{anode-cathode} values of other channels, and thereby reduce EMI generated by all channels. At the turn-off of a pulse, −dIₑₘᵢₛₛ(t>t_{steady})/dt may be moderated by, for example, limiting a slew rate of a control voltage on control grid 130.

To manage the electron-optical phenomena of or related to Iₑₘᵢₛₛ, ΔV_{anode-cathode}, EMI and possible cross-talk or current leakage between conducting channels of tube 100, controller 300 may use input interface 320 to sense ΔV_{anode-cathode} for each of plural cathodes 120A, 120B and 120C by measuring a voltage of conductors 122A, 122B and 122C with respect to anode potential on conductor 162 see FIG. 2). By similar means, not shown, Iₑₘᵢₛₛ may be measured for each cathode 120. A calculated or otherwise quantified value of space charge Qᵥₒₗ(gap) within the gap between each cathode and its cathode interface structure 168 may be estimated from the known or expected plural Iₑₘᵢₛₛ values and ΔV_{anode-cathode} values. This may take into account that uncollected (e.g. reflected) electrons and secondary electrons within the anode 160 volume may indeed penetrate into a first cathode-to-cathode-interface-structure gap when a first cathode's ΔV_{anode-cathode} is lower than the ΔV_{anode-cathode} value(s) of a second or third cathode. More broadly, all sources of such uncollected electrons residing with the hollow volume of anode 160 and cathode interface structures 168 may be described by a general electron population density distribution function n_{e,anode}(x, y, z, vₓ, v_{y}, v_{z}, t) for use in such control calculations. Such a n_{e,anode}( ) expression and a containment-escape function of electrons from volume 160 may be derived, developed or estimated and stored in controller 300 during design, manufacture, test, set-up or calibration of tube 100, to aid the aforementioned during-operation estimations of Qᵥₒₗ(gap) and other desired parameters. A cathode 120 may still function with the presence of some electron space charge in its cathode-cathode interface structure gap, but its target value of Iₑₘᵢₛₛ may need to be reduced to avoid encountering a Child's Law limit to Iₑₘᵢₛₛ. Preferably this target Iₑₘᵢₛₛ value is set or adjusted by the Table 1-2 parameter. Controller 300 may assert time-varying grid control signal(s) via output interface 310 upon conductors 132A, 132B or 132C to set target Iₑₘᵢₛₛ values for all cathodes 120. Controller 300 may comprise one or more high-speed computing devices such as a microprocessor, a digital signal processor (DSP) or a field-programmable gate array (FPGA) to perform such dynamic (time-changing) measurements and computation of grid control signals. This may be done on a current-pulse-by-current-pulse basis, or may even be done within any single current pulse (or DC current duration). Alternatively, adjustment of grid control signal(s) via output interface 310 may be done less frequently, in response to system-wide conditions (see FIG. 2), such as motor 280 parameters as sensed by sensors 350 via input interface 320. Sensor(s) 350 may, for example, comprise one or more current transformers to measure a) a current in transformer 220 primary windings 230, b) a current in transformer secondary windings 240, and/or c) a current in motor windings 282, among many types of sensors and other parameters. More broadly, sensor(s) 350 may also comprise an operator control input, such as a throttle or accelerator pedal input on a vehicle, without limitation. Further broadly, sensors 350 may detect a change of loading or torque upon motor 280, which may arise “spontaneously” from the point of view of controller 300 of system 200. Any and/or all of these system 200 impedances, voltages, currents or anticipatory control commands may (or may not) be considered in a transconductance or a transfer function of tube 100. Whether to measure and adjust for system 200 influences upon electron-optical performance of tube 100 may be a matter of optional design choice made possible within the disclosure. There may be many design choices provided; for example, within pulse-by-pulse determination of the plural target Iₑₘᵢₛₛ values, the actual value(s) of Iₑₘᵢₛₛ for previous pulse(s) or pulses of other channels may be used, since it is contemplated that tube 100 may pulse at frequencies of 10 kHz, 100 kHz, 1 MHz and higher, which may be much faster than load changes, for example, may occur. Alternatively, controller 300 may sense when a Child's Law limit has been reached if a target value of Iₑₘᵢₛₛ is not obtained (the actual value falls low of a well-predicted target value), then make appropriate decisions or changes. Alternatively, each channel may be fitted with a comparator to trigger termination of a pulse in time if Iₑₘᵢₛₛ exceeds a certain value. Alternatively, the Table 1-2 control on Iₑₘᵢₛₛ may be set low enough that Child's Law limits may never be reached, though this may result in more heat wasted in tube 100. Regardless of these and many other possible choices within the disclosure, the disclosed anode baffle structure 164 comprising cathode interface ducts 168 for each cathode-emitter 120 in a multi-cathode electron tube allows a variety of time-varying electron fluxes to pass through cathode interface structures 168 or to be collected, in part, to the anode on surfaces of cathode interface structures 168, even with fixed potentials on grids 130, 140, etc. Therefore, within the disclosure, the practitioner may be beneficially given many design choices whether to operate the tube in a simple, passive manner or to implement various increasingly sophisticated degrees of control over the internal electron optics of tube 100. Cathode interface structures 168 generally improve electrical performance of tube 100 in all methods of control, as well as enabling, in part, the more sophisticated dynamic and channel-correlated adjustment of cathode 120 parameters to provide still further improved performance.

The example implementation tube 100, as provided in FIGS. 1 and 3, within system 200 of FIG. 2, provides excellent control and synthesis options for three (or two or more than three) independent time-varying power signals with which to drive a multi-channel load or several loads. The three-phase transformer and three-phase motor load of system 200 of FIG. 2 may be illustrative of many of these power control options, and in particular the synthesis of sinusoidal-like current waveforms may be instructive. Those skilled in the art may recognize many other control options and waveforms of the disclosure that may be beneficial in other applications. In an example implementation for synthesizing sinusoidal waveforms, tube 100 may be provided with cathode 120 configurations adapted for “switch mode” or pulsed current conduction. This example illustrates synthesis of 1 to 1,000 Hz sinusoids using 10 kHz, 100 kHz, 1 MHz and higher pulse frequencies. Controller 300 may assert time-varying grid control signal(s) via output interface 310 to control grids 130 (in combination with grids 140, 150, etc.) which cause channel cathodes 120 to emit current or not. As described, the “on” state may comprise variable target Iₑₘᵢₛₛ levels. This may be done for heat efficiency of tube 100 operation.

As discussed above relative to system 200 of FIG. 2, it may be desired, as an example, to generate 3-phase AC power with which to operate electric motor 280. As mentioned there, transformer 220 with center taps offers one method of converting mono-polar or unipolar pulses or waveforms, generated by the combination of voltage source 210 and tube 100, into bipolar AC signals. Here is an example of generating approximately sinusoidal waveform(s) to be sent through the primary windings 230 of transformer 220. One method of generating unipolar pulse trains for sending through primary windings 230 for conversion to bipolar sinusoidal waveforms on the secondary side of a transformer comprises composing unipolar pulse trains having a sinusoidally-varying-in-time energy content. In some implementations and in certain operational regimes, it may be possible to use voltage source 210 and tube 100 to produce approximately “square” current pulses. In simplest form, this means that each pulse received at transformer 220 quickly transitions from near zero volts to V_{primary}, which may be V_{primary}≈ΔV_{source}−ΔV_{anode-cathode}, and may be constant when Iₑₘᵢₛₛ is held constant, where V_{source} may be 10,000 volts as in FIG. 2. During the on-time of each pulse, a current flows through one of the primaries 230 which may be approximately Iₑₘᵢₛₛ of one cathode 120 of tube 100. The end of each pulse quickly transitions from V_{primary} to near zero volts, in this idealized example. The pulse length is a duration of time Δtₚᵤₗₛₑ. The energy transferred to the primary winding and to a magnetic field in the transformer core may be approximately, ideally

E_{xfr.pulse}=V_{primary}·Iₑₘᵢₛₛ·Δtₚᵤₗₛₑ=V_{primary}·Q_{xfr}, Eqn. 5

where Q_{xfr} is an amount of charge displaced through winding 230 during the pulse. In this idealized case, it may be assumed that V_{primary} and Iₑₘᵢₛₛ are constant in time and throughout the duration of any one pulse, so to generate a sinusoidally varying energy transfer into the transformer core may become a matter of simply pumping charge through primary winding 230 with a sinusoidally varying time profile. As mentioned above, it may be desired to modulate current through primary windings 230A, 230B and 230C at effective frequencies of 10 kHz, 100 kHz, 1 MHz and higher, so that transformer core 225 may optionally be a ferrite material core or even an air core, for light weight and small size. At a point in time of maximum energy transfer into transformer 220 core 225, Δtₚᵤₗₛₑ may be short enough not to magnetically saturate core 225. Also, a time duration Δt_{off} between pulses may be long enough for magnetic flux in the core to partially or fully collapse. Therefore at a time of maximum energy transfer to and through core 225, it may be desirable to maximize Δtₚᵤₗₛₑ and minimize Δt_{off} within the magnetic restrictions mentioned. This defines a “square” pulse train pulse frequency and pulse width for maximum energy deposition in and through core 225. There may be some energy losses within core 225. Capacitors 254 across secondary windings 240 may be used to filter and essentially “merge” the charge pulses into a smoother current waveform more suitable for driving motor 280. From this maximum, lesser amounts of charge transfer per unit time may be composed in a unipolar sinusoidal time profile by systematically reducing Δtₚᵤₗₛₑ and increasing Δt_{off} according to a simple calculation. At a point in time of minimum charge (energy) transfer, there may be no pulses for a short period of time, then Δtₚᵤₗₛₑ may be gradually increased and Δt_{off} gradually reduced according the same calculation until the maximum Δtₚᵤₗₛₑ and minimum Δt_{off} are again reached. This overall composed unipolar sinusoid may be sped up or slowed down by manipulating Δtₚᵤₗₛₑ and Δt_{off} within the magnetic constraints mentioned above. The overall energy transferred to motor 280 may be varied by increasing or decreasing a time-density of “on” pulses or by increasing or decreasing Iₑₘᵢₛₛ of tube 100. V_{primary} may tend to increase and decrease along with Iₑₘᵢₛₛ, due to electron-optics-caused impedance characteristics of the electron beam(s) inside tube 100, as indicated herein, among others. Again, the above energy transfer analysis is within an approximate, idealized “square” pulse regime of switched operation of tube 100. For a variety of reasons, pulses may not be “square” in time, or pulse shapes other than square, such as Gaussian or Lorenztian, may be desired and programmed onto control grid 130, in which case the energy transferred over an increment of time from 0 to t may not be well represented by Eqn. 5 above but more closely approximated by

E_{xfr}(t)=∫ₜ₌₀^{t}V_{primary}(t)Iₑₘᵢₛₛ(t)dt Eqn. 6

In some multi-channel implementations of the disclosed vacuum tube, it may be possible to synthesis two, three or more sinusoidal waveforms with which to drive or power a 2-phase, 3-phase or higher poly-phase multi-channel load. This may simply done by replicating the function and algorithms described above for one phase within a controller, such as 300 in FIG. 2, for plural phases, and adding coordination among the phases. For example, with a two-channel tube of the disclosure, at least one controller may be configured to synthesize a first sine-wave current waveform through a first load and synthesize a second sine-wave current waveform through a second load, wherein the first sine-wave current waveform may include a phase relationship with the second sine-wave current waveform. In a three-phase system of the disclosure, quadrature signal output may be generated which may give unique and unambiguous phase offset or phase-rotation information to the multi-phase load, regardless of the state of the load.

The analysis above may be only one way of synthesizing power waveforms to drive a three-phase motor. The above analysis may be a hybrid pulse density modulation (PDM) scheme using energy or charge as a “transmitter” control parameter. The above method takes advantage of tube 100's ability to modulate pulse peak current as well as control power, charge, energy and duration of each pulse on a pulse-by-pulse basis. Different algorithms may exist for generating sinusoidal waveforms, however. Digital-to-analog converters used for audio playback use some of these and may be applicable. Delta-Sigma modulation (DSM) may be frequently used for its ease of control and fidelity of a reconstruction filter at the “receiver”. In the case of system 200 of FIG. 2, the receiver may be motor 280 and a reconstruction filter adapted for high power handling may be put in place of or augment capacitors 254 after secondary of transformer 220. Transformer 220 may be viewed as a transmission channel (that is, three parallel channels) of signal theory, and treated within that theory for pulse frequency modulation (PFM), pulse code modulation (PCM), pulse width modulation (PWM) and pulse amplitude modulation (PAM). In that view, tube 100 may be a transmitter or modulator and may be improved with a pulse forming network, matching network, anti-aliasing filter (aliasing not in the sense of a measurement on the secondary side falsely detecting high-frequency Fourier components, but simply removing unnecessary higher-order components) and/or other functions conventional in signal transmission theory. Transformer 220 itself may be modeled as part of a low-pass filter or integrator fitted with or combined to make a demodulator after the secondary windings of transformer 220. More generally within the disclosure, practitioners may model, manipulate and exploit the intrinsic and extrinsic lump and individual impedances of inductors, capacitors, transformer windings, cores, transmission wires, guides, motors and other elements of the load for each channel. Using a combination of phase, frequency and time modulation, practitioners may construct suitable waveforms and control the manipulation of these waveforms using a priori and causal signal references to provide optimal energy transfer and reduce EMI. Those skilled in motor control may recognize several other electrical effects which may be mapped back to control of tube 100 for enhancement or avoidance. Only a brief description of the major aspects has been provided herein, for purposes of illustrating operation of tube 100. While the above brief description pertained to a current-pulsed implementation, it would be alternatively possible to directly synthesize analog sinusoidal waveforms using tube 100. This has been avoided herein due to the extremely low frequencies (such as ˜10 Hz) which may be encountered to drive certain types of electric motors at slow rotation speed, thereby requiring a larger transformer 220 and possibly dissipating larger amounts of waste heat in tube 100.

### Example Implementation

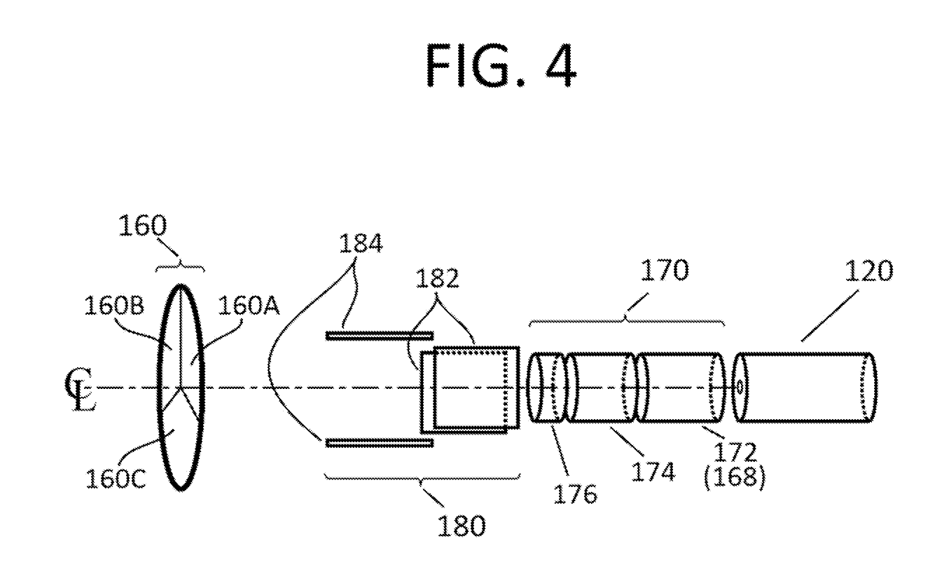

FIG. 4 is a simplified line drawing of one example implementation of a cylindrically symmetric electron tube comprising one common cathode emitter source and three anode structures or plates. Thus FIG. 4 depicts a multi-channel vacuum tube of the disclosure wherein the first electrode may include a cathode, wherein the second electrode may include a first anode, and wherein the third electrode may include a second anode, and further wherein a fourth electrode may include a third anode. In FIG. 4, only a mechanical concept schematic of the principal electrodes is given, omitting the vacuum envelope and construction details, which may be similar to standard vacuum tubes. Likewise, the principal electrical topology involving the tube's electrodes as shown in FIG. 2 are omitted, but an electrical source 210 may be present but with its negative terminal connected to the cathode-emitter electron source 120; the three anodes may be connected through three loads, also not shown, back to the positive terminal of electrical source 210. As one example of a single-cathode-plural-anodes implementation, FIG. 4 depicts an apparatus similar to an electron gun and beam system that may be used in a cathode ray tube (CRT). According to the example depicted concept of the disclosure, one electron beam may be steered to three separate anodes, much as the electron gun/beam in a CRT of a television (TV) set may be steered to hit each of the three red-green-blue phosphor dots, as well as perform an X-Y raster scan to cover the entire display area.

In more detail, in the apparatus of FIG. 4, a cathode-emitter electron source 120 is provided, which may be similar to one of the cathode assemblies 120A, 120B or 120C of FIG. 1; source 120 may comprise control grid(s), screen grid(s), extraction electrodes and so forth, similar to the corresponding cathode assemblies 120 of FIG. 1. Downstream of source 120, in the direction of electron flow, may be a beam forming section 170 by way of example and not limitation. The elements 172, 174 and 176 of beam former 170 may be near anode 160 potential, whereby a) any electron flux emitted from 120 may be accelerated to near maximum velocity but b) essentially no electrons impinge upon or are collected within 170. It is also possible that elements 172, 174 and 176 of 170 may be biased at a potential even more positive than anode potential, because this type of electron-optical chain or column may perform better with such bias in the event of strong ΔV_{anode-cathode} collapse, as may occur in this multi-anode example as well as in the multi-cathode example given above. Beam forming section 170 may serve as a focusing and defocusing lens, with which a diameter of an electron beam traveling parallel to the indicated center-line axis may be selected. In operation as a lens, 170 may, for example, may function similarly to an “einzel lens” known in the art of electron optics. In a common method of operating an einzel lens, entry and exit lens elements 172 and 176, respectively, may be fixed at anode potential (or at a potential even more positive than anode potential, as mentioned above), while middle element 174 may be varied in voltage to focus the already-accelerated electron beam according to known principles. Downstream of lens 170 may be provided beam steering section 180. Beam deflector 180 may comprise, for example, two sets of electrostatic deflection plates, one pair of plates 182 for X-deflection and another pair of plates 184 for Y-deflection. The naming and orientation of “X” and “Y” deflection directions is arbitrary, but both directions may be orthogonal to the center-line axis direction and orthogonal to each other. Other means of deflecting an electron beam may be known and may be used, such as electromagnetic coils. Thus in this multi-anode example implementation, at least a portion of the vacuum tube may be configured to at least one of focus a beam of electrons emitted from the cathode, and steer the beam of electrons emitted from the cathode. Downstream of deflection section 180 may be provided collector anode 160. Anode 160 may comprise three (or two or more than three) electrically-isolated collector plates 160A, 160B and 160C. FIG. 4 depicts three partial-circle angular sectors as the three anode plates, with the overall circle centered on the electron beam center-line axis. Many other configurations of plural anode collectors may be implemented within the disclosed scope herein. For example, an improved anode array may comprise plural electrically-isolated re-entrant or hollow beam dumps supplied with cooling from outside the vacuum tube wall (not shown).

The apparatus of FIG. 4 may be caused to broaden or defocus its electron flux by selection of parameters for lens 170, whereby the electron flux irradiates all three anode collectors 160A, 160B and 160C. Control grids within cathode assembly 120 may be used to modulate an electron current received at all three anode collectors, optionally simultaneously and equally. More flexibly, especially in relation to a three-channel load such as in FIG. 2, lens 170 may be adjusted to select a smaller electron beam diameter which then may be steered by deflector 180 to impinge only upon one selected anode collector 160A, 160B or 160C. Clearly, a thus-focused electron beam may be sequentially steered to any of the three anode collectors, while control grids within cathode assembly 120 modulate a current received at each collector. The electron beam may be turned off or “blanked” during a steering sweep or deflection event between anode elements. Lens 170 may be adjusted to give a beam diameter of size selected to irradiate two of the three anode collector elements simultaneously, with some deflection by section 180 to select which two anode collectors are irradiated. Various pulsed, analog/variable and other current control options may be implemented in the apparatus of FIG. 4, similar to those discussed relative to FIG. 2 and the first example implementation, above. Therefore, in this multi-anode example implementation and example at least one of the first anode and the second anode may be configured to capture the beam of electrons which are at least one of focused and steered by at least the portion of the vacuum tube.

As will be appreciated by one skilled in the art, the present disclosure may be embodied as a method, system/apparatus, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

The flowcharts and diagrams in the figures illustrate the architecture, functionality, and operation of possible implementations of systems adaptable to methods and computer program products according to various implementations of the present disclosure. It will also be noted that each element in the diagrams and/or flowchart illustrations, and combinations of elements in the diagrams and/or flowchart illustrations, can be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A vacuum tube comprising:
a plurality of electrodes;
a first electrode of the plurality of electrodes configured to operatively connect to an electrical source;
a second electrode of the plurality of electrodes configured to operatively connect to a first load of a plurality of loads, wherein the first electrode is configured to complete a first circuit through the second electrode and the first load; and
a third electrode of the plurality of electrodes configured to operatively connect to a second load of the plurality of loads that is independent from the first load, wherein the first electrode is configured to complete a second circuit through the third electrode and the second load.

2. The vacuum tube of claim 1 wherein the first electrode includes an anode, wherein the second electrode includes a first cathode, and wherein the third electrode includes a second cathode.

3. The vacuum tube of claim 2 further comprising at least one anode baffle, wherein the at least one anode baffle is configured to restrict electron flow to near zero from the first cathode to the anode and from the second cathode to the anode, except as electron flow is permitted via at least one cathode interface structure.

4. The vacuum tube of claim 3 further comprising at least one cathode interface structure, wherein the at least one cathode interface structure includes electrically conductive material.

5. The vacuum tube of claim 3 further comprising at least one cathode interface structure, wherein the at least one cathode interface structure includes a non-perforated surface.

6. The vacuum tube of claim 3 further comprising at least one cathode interface structure, wherein the at least one cathode interface structure is near anode electrical potential.

7. The vacuum tube of claim 3 further comprising at least one cathode interface structure, wherein the at least one cathode interface structure includes a hollow duct through which emitted electrons flow to the anode.

8. The vacuum tube of claim 3 further comprising at least one cathode interface structure, wherein the at least one cathode interface structure includes a hollow duct through which emitted electrons flow to the anode and wherein the hollow duct becomes larger in at least one of inside-diameter and inside-width with distance toward the anode.

9. The vacuum tube of claim 3 further comprising at least one cathode interface structure, wherein the at least one cathode interface structure is configured to serve as an auxiliary anode surface, wherein an effective electron collection surface area of the anode becomes larger as the anode-to-cathode potential difference decreases.

10. The vacuum tube of claim 3 further comprising at least one cathode interface structure, wherein the at least one cathode interface structure is configured to create an accelerating electric field to draw electrons away from the cathode toward the anode.

11. The vacuum tube of claim 3 further comprising at least one cathode interface structure, wherein the at least one cathode interface structure is configured to avoid concentration of high electric fields proximate to the cathode.

12. The vacuum tube of claim 3 further comprising at least one cathode interface structure, wherein the at least one cathode interface structure is configured to prevent electrons originating at the first cathode from reaching the second cathode.

13. The vacuum tube of claim 1 wherein the first electrode includes a cathode, wherein the second electrode includes a first anode, and wherein the third electrode includes a second anode.

14. The vacuum tube of claim 13 wherein at least a portion of the vacuum tube is configured to at least one of focus a beam of electrons emitted from the cathode, and steer the beam of electrons emitted from the cathode.

15. The vacuum tube of claim 14 wherein at least one of the first anode and the second anode are configured to capture the beam of electrons which are at least one of focused and steered by at least the portion of the vacuum tube.

16. The vacuum tube of claim 1 further comprising at least one controller configured to synthesize a first sine-wave current waveform through the first load and synthesize a second sine-wave current waveform through the second load, wherein the first sine-wave current waveform includes a phase relationship with the second sine-wave current waveform.
